(19) United States
(12) Patent Application Publication
(10) Pub. No.: US 2006/0041647 A1
(43) Pub. Date: Feb. 23, 2006

(54) System and method for profiling messages

(76) Inventors: Michael Perham, Austin, TX (US); Matthew Sanchez, Round Rock, TX (US)

Correspondence Address: RICK B. YEAGER, ATTORNEY, 10805 MELLOW LANE, AUSTIN, TX, 78759, US

(21) Appl. No.: 11/079,605

(22) Filed: Mar. 14, 2005

Related U.S. Application Data
(60) Provisional application No. 60/602,250, filed on Aug. 17, 2004.

(51) Int. Cl. G06F 15/177; G06F 15/16

(52) U.S. Cl. 709/220; 709/201

(57) ABSTRACT

A resource-optimization system is set up to characterize the content of client messages before the transmission of those messages to final Web service endpoints and to route those messages to appropriate Web service endpoints dynamically, based on message content. A metadata storage stores service profiles that characterize resource capabilities of Web service endpoints. A service proxy employs a profiler engine to analyze the message resource requirements for a client message and identify those capabilities in a message profile tag appended to that message. The service proxy further employs a resource-allocation engine to match the message resource requirements identified in the message profile tag with the most appropriate Web service profile stored in metadata storage. The resource-allocation engine then routes the message to the Web service endpoint identified in that Web service profile. And the service proxy employs an invocation engine to invoke the Web service and carry out the message's request.

### CROSS-REFERENCE TO RELATED APPLICATIONS

This application claims the benefit of PPA Ser. No. 60/602,250, filed Aug. 17, 2004 by the present inventors.

### FIELD OF THE INVENTION

This innovation relates to Web services, and, more particularly, to methods that route electronic messages to Web service endpoints with appropriate capabilities for the efficient processing of those messages.

### BACKGROUND OF THE INVENTION

Web Services

The promise of the Internet is an open e-business platform where companies can do business spontaneously with anyone, anywhere, and anytime without requiring that companies abandon their existing software applications and infrastructures. Increasingly companies rely on the Internet to obtain loosely coupled Web services deployed by Web service providers on application-based servers, which are computers on networks that mange the networks.

Web services are business-enterprise computer applications that can be utilized singly or collectively to accomplish a wide range of intended purposes, such as determining health-care patients' eligibility for benefits, submitting health-care claims, and providing stock quotes. Web services help companies dramatically cut costs, increase revenues, and improve competitive agility by combining existing, heterogeneous systems into cross-functional, multi-company applications. For example, Web services designed for insurance companies help them rapidly automate their business processes, eliminating paper and manual touches and saving them tens of millions of dollars annually. To supply such valuable and widely needed services, Web services providers may offer multiple Web services to client businesses.

Because Web services can operate independently of a particular computer language, platform, or location, a client business and a Web service may each use different computer languages, platforms, and locations in widely distributed systems over one or more networks.

Open Web service standards have been developed for compatibility among Web service applications. A standard called SOAP (Simple Object Access Protocol) has been developed to define the format of messages exchanged among applications. The content of messages, such as a request for an action to be performed by a Web service, is currently described in WSDL (Web Services Description Language), which is an XML (Extensible Markup Language)-formatted language and which serves as a Web service's interface. Web services are cataloged in a Web based directory and infrastructure called UDDI (Universal Description, Discover and Integration), which is an Internet registry where businesses list themselves according to their services. Communications between a client business and a Web service further rely on the use of a shared transport protocol, such as HTTP (Hypertext Transport Protocol), which enables communications over the Internet.

Typically a client business employs a client application to communicate from its Web site over the Internet according to these standards, to obtain the Web services offered by a Web service provider from its server-based Web site. The Web service provider uses the same standards to reply to a client. Other known or not-yet-known Web service protocols and standards may be used for these communications.

The Web service endpoint is the physical location of the Web service on a server and implements the Web service interface.

Web Service Capabilities and Expenses

For processing client businesses' messages, Web services with lower capabilities are typically less expensive to buy, operate, and maintain than those with higher capabilities. For example, a Web service resource with comparatively higher capabilities may require a larger CPU (central processing unit), more memory, and more IO buses than a Web service with lower capabilities, and all of these additional resources may increase the cost of the high-capability Web service to users.

The capacity of a Web service can be expressed in terms of units of work. For example, one Web service might be able to check the spelling of up to 10,000 words in a text file and thus have a capacity of 10,000 units of work. Another, more expensive Web service might be capable of checking the spelling of up to 100,000 words and so have a capacity of 100,000 units of work. It would be more cost effective for a user with a text file of 9,000 words to employ the 10,000-units-of-work Web service. But if a user with a text file of 90,000 tried to use the 10,000-units-of-work Web service on that file, the Web service might be overloaded and become unusable.

To cite another example, one Web service for validating patient insurance claims might be capable of handling a batch of ten claims at a time, and so have a capacity of ten units of work. Such a Web service could handle code like the following, which has only three claims:

<batch of claims>

<claim></claim>
<claim></claim>
<claim></claim>

<batch of claims>

Another, more expensive Web service for validating patient insurance claims might have a capacity of one thousand units of work.

Some companies offer expensive high-powered computation grids for large loads. Other companies can pay to use these grids for specific time periods.

Additionally, Web services can be characterized by other kinds of capabilities than units of work. In connection with patient claims filing, for example, a Web service application may employ a loose chain of Web services with the following distinct capabilities:
Professional—for claims from doctors' offices
Institutional—for claims from hospitals
Dental—for claims from dentists' offices
   The Capacity VS Expense Problem

To operate cost-effectively, businesses need to employ Web services with sufficient capabilities to accomplish those businesses' service requests but without extra capabilities that would increase expenses.

To accomplish this requirement effectively, businesses need an automatic method that would enable them to characterize the content of such messages before the transmission of these messages to final Web service endpoints, so that these messages can be routed properly to appropriate Web service endpoints. However, prior techniques have not made this possible.

Currently, if a routing system for Web services tries to handle a peak, high-units-of-work load with a lower-units-of-work Web service's endpoint, the server for that endpoint can become overloaded and usable, which can delay or prevent the accomplishment of the desired service. A service delay or loss of service may cause the Web service provider's SLA (Service Level Agreement) level to fall off, resulting in customer dissatisfaction or in expensive penalties.

On the other hand, some routing systems for Web services use higher-capacity Web services for all service requests to avoid overloading their servers, but this is often an unnecessarily expensive solution. For example, peak loads may only occur 10% of the time for such a system, making 90% of its operations overly expensive.

Therefore there is a need for a system and method that provides an automatic method to characterize the content of client messages before the transmission of these messages to final Web service endpoints, so that these messages can be routed dynamically, based on message content, to appropriate Web service endpoints. Such a system and method would help minimize the cost and optimize the performance of Web services.

### BRIEF SUMMARY OF THE INVENTION

These and other needs are addressed by the present invention. The following explanation describes the present invention by way of example and not by way of limitation.

It is an aspect of the present invention to provide a resource-optimization system and method to automatically characterize the content of client messages before the transmission of those messages to final Web service endpoints and to automatically route those messages to appropriate Web service endpoints dynamically, based on message content.

It is another aspect of the present invention to provide a metadata storage to store service profiles that characterize the capabilities of Web service endpoints.

It is another aspect of the present invention to provide Web service profiles that characterize the capabilities of Web service endpoints.

It is another aspect of the present invention to provide a service proxy to identify the capabilities required for a client message and route the message to an appropriate Web service endpoint.

It is another aspect of the present invention to provide profiler engine in the service proxy to analyze the content of a client message and add to that message a message profile tag about that content.

It is another aspect of the present invention to provide a resource allocation engine in the service proxy to compare the required capabilities specified in a message profile tag and the capabilities listed in the Web service profiles and to route the corresponding message to the most appropriate endpoint.

It is another aspect of the present invention to provide an invocation engine in the service proxy to invoke the Web service at the endpoint to which the message has been directed.

These and other aspects, features, and advantages are achieved according to the method and apparatus of the present invention. In accordance with the present invention, a resource optimization system is set up to characterize the content of client messages before the transmission of those messages to final Web service endpoints and to route those messages to appropriate Web service endpoints dynamically, based on message content. A metadata storage stores service profiles that characterize the capabilities of Web service endpoints. A service proxy employs a profiler engine to analyze the capabilities required for a client message and identify those capabilities in a message profile tag appended to that message. The service proxy further employs a resource-allocation engine to match the required capabilities identified in the message profile tag with the most appropriate Web service profile stored in metadata storage. The resource-allocation engine then routes the message to the Web service endpoint identified in that Web service profile. And the service proxy employs an invocation engine to invoke the Web service and carry out the message's request.

### BRIEF DESCRIPTION OF THE DRAWINGS

The following embodiment of the present invention is described by way of example only, with reference to the accompanying drawings, in which:

FIG. 1 is a block diagram showing an operating environment in which embodiments of the present invention may be employed;

FIG. 2 is top-level flow chart that illustrates a process for automatically characterizing the content of client messages before the transmission of those messages to final Web service endpoints and to automatically route those messages to appropriate Web service endpoints dynamically, based on message content;

FIG. 3 is a flow chart that illustrates a process for setting up a resource-optimization system;

FIG. 4 is a block diagram of a metadata storage;

FIG. 5 is a block diagram that illustrates the components used by a service proxy;

FIG. 6 is a flow chart that illustrates a process for determining client-message resource requirements;

FIG. 7 is a block diagram that illustrates SOAP information contained in a client application message;

FIG. 8 is a flow chart that illustrates a process for directing a client message to an appropriate resource for execution;

FIG. 9 is a block diagram that illustrates a typical computer system, representing a Web service provider server on which embodiments of the present invention can be implemented;

FIG. 10 is a block diagram showing an alternate operating environment in which embodiments of the present invention may be employed, using a resource-optimization system connected to a client computer; and

FIG. 11 is a block diagram showing a second alternate operating environment in which embodiments of the present invention may be employed, using a widely dispersed system.

### DETAILED DESCRIPTION

The following description explains a resource-optimization system and method to automatically characterize the content of client messages before the transmission of those messages to final Web service endpoints and to automatically route those messages to appropriate Web service endpoints dynamically, based on message content. The details of this explanation are offered to illustrate the present invention clearly. However, it will be apparent to those skilled in the art that the concepts of present invention are not limited to these specific details. Commonly known elements are also shown in block diagrams for clarity, as examples and not as limitations of the present invention.

Operating Environment

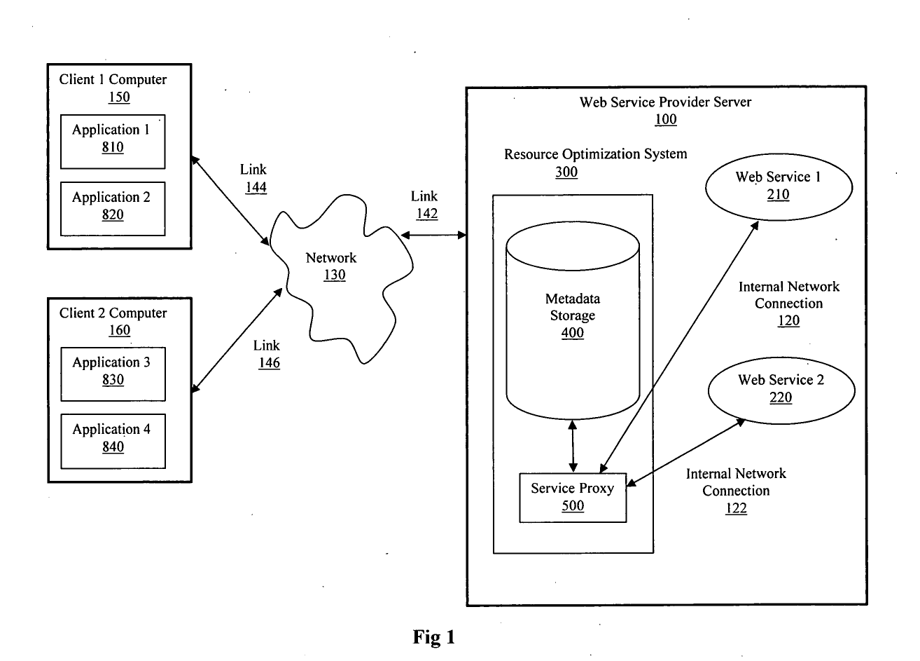

An embodiment of an operating environment of the present invention is shown in FIG. 1. A Web service provider employs a server 100 to deliver one or more Web services 210 and 220, which may or may not be related and which may supply independent or combined processing, to client businesses. The server 100 may be a personal computer or a larger computerized system or combination of systems.

One or more client business, which may be related or of different types, employ one or more computers 150 and 160 to communicate over links 144 and 146, a communications network 130, and a wired or wireless link 142 with the Web service provider server 100. The client business computers 150 and 160 may be personal computers or computerized systems or combinations of systems comprising servers, for example.

The network 130 may be the Internet, a private LAN (Local Area Network), a wireless network, a TCP/IP (Transmission Control Protocol/Internet Protocol) network, or other communications system, and may comprise multiple elements such as gateways, routers, and switches.

To accomplish dynamic routing of electronic messages, Web service provider server 100 employs a resource-optimization system 300, comprising a metadata storage 400 and a service proxy 500. The service proxy 500 communicates with one or more Web services 210 and 220 through one or more internal network connections 120 and 122. In an embodiment, these resource-optimization-system 300 elements comprise a discrete system, but in other embodiments they can be distributed more loosely throughout the operating environment, as necessary and advantageous.

Through the operating environment shown in FIG. 1, one or more client applications 810, 820, 830, and 840, which may or may not be related to each other, from the same client business or different ones, can communicate with one or more Web services, 210 and 220, offered by Web service provider server 100. These client applications are software programs with one or more sequences of instructions that can request services or information from general or specific Web services.

Process of Supplying Dynamic Routing—Overview

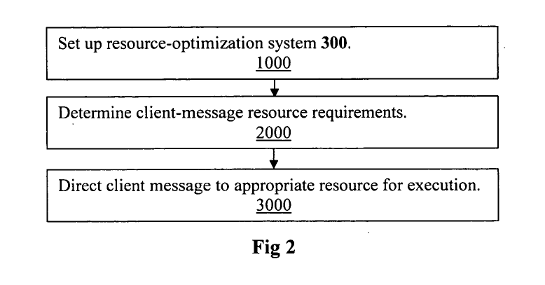

FIG. 2 is top-level flow chart that illustrates a process for a Web service provider to automatically supply dynamic routing of client messages to a Web service provider through the operating environment shown in FIG. 1. It will be useful to explain the steps in this process briefly from a high level and then to expand elements of this explanation in detail.

Step 1000 in FIG. 2. Set up resource-optimization system 300.

The Web service provider sets up a resource-optimization system 300, shown in FIG. 1, comprising a metadata storage 400 and a service proxy 500.

Step 2000 in FIG. 2. Determine client-message resource requirements.

The service proxy 500 in FIG. 1 receives a client message, determines the resource requirements of that message, and adds to that message a message profile tag stating the resource requirements. In an embodiment, the message profile tag can be a SOAP message profile tag, as explained below.

Step 3000 in FIG. 2. Direct client message to appropriate resource for execution.

The service proxy 500, shown in FIG. 1, reads the message profile tag 512 and compares the capability requirements of the message with the resource capabilities of web service profiles stored in the metadata storage 400. The service proxy 500 then selects an appropriate Web service for the message, sends the message to that Web service, and invokes the Web service.

Setting Up a Resource-Optimization System

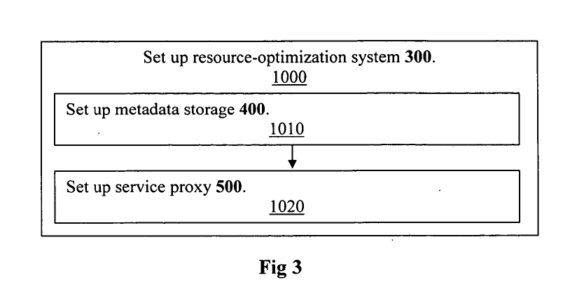

FIG. 3 illustrates a process for a Web service provider to set up a resource-optimization system at Step 1000, shown in FIG. 2.

Setting Up Metadata Storage

Step 1010 in FIG. 3. Set up metadata storage 400.

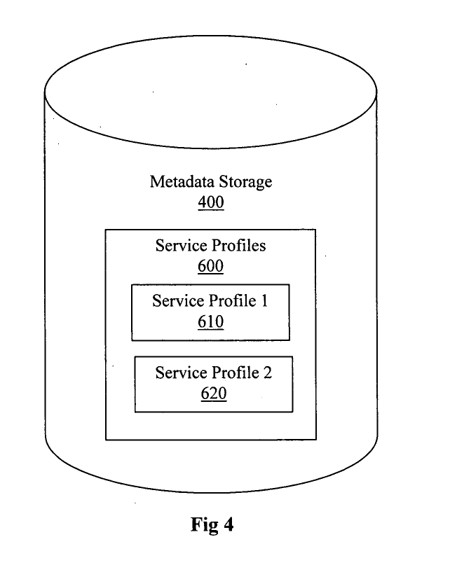

The Web service provider sets up a metadata storage 400, shown in FIG. 4, which may be non-volatile data storage and which stores service profiles 600 about the Web services, such as Web service 210 and 220 shown in FIG. 1.

Service Profiles

Service profiles 600, as shown in FIG. 4, represent data a Web service provider creates to specify information about the resource capabilities of Web services such as 210 and 220 shown in FIG. 1.

The resource capabilities to be characterized may vary depending on the type of Web service applications and Web services involved. In an embodiment, a useful capability to be characterized is the amount of processing time (PT) required to complete a given task, based on a human operator's manual, empirical testing of Web services. In another embodiment, such processing time may be determined through automatic software testing of Web services. Another useful capability that might be characterized in another embodiment is the memory requirement of a Web service.

For example, a human operator might manually determine that Web service 1 210, shown in FIG. 1, has a processing time of one minute to complete up to 10,000 units of work, representing that Web service 1 210 can file up to 10,000 health care claims in that time. The operator may also determine that more expensive Web service 2 220 has a processing time of one minute to complete up to 100,000 units of work, representing that Web service 2 220 can file up to 100,000 claims in that time.

The operator can set up service profile 1 610, shown in FIG. 4, to specify that Web service 1 210, shown in FIG. 1, has a capacity of 10,000 units of work for claims filing. Service profile 1 610, shown in FIG. 4, could then contain the following JAVA code for the endpoint (EP) for Web service 1 210, shown in FIG. 1:

EP1=10,000 PT

The operator can also set up service profile 2 620, shown in FIG. 4, to specify that Web service 2 220, shown in FIG. 1, has a capacity of 100,000 units of work for claims filing. Service profile 2 620, shown in FIG. 4, could then contain the following JAVA code for the endpoint (EP) for Web service 2 220, shown in FIG. 1:

EP2=100,000 PT

Note that a Web service can potentially have multiple service profiles 600 for different types of capacities, for example for units of work or types of capacities such as claims filing for doctors, hospitals, or dentists.

Setting Up a Service Proxy

Returning to FIG. 3, in an embodiment a Web service provider also needs to accomplish the following step:

Step 1020 in FIG. 3. Set up service proxy 500.

A service proxy 500, as shown in FIG. 1, may be a computer software program comprising one or more engines. In an embodiment, the Web service provider sets up a service proxy 500 to receive all client messages first and afterwards to send them on to the correct Web service, for example to Web service 1 210.

Elements Employed by a Service Proxy

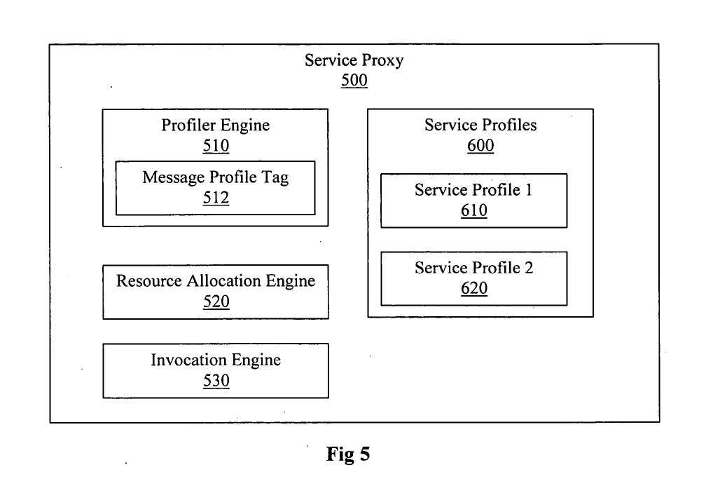

FIG. 5 is a block diagram that illustrates the elements that a service proxy 500 employs in this embodiment, which comprise
A profiler engine 510;
A resource allocation engine 520;
An invocation engine 530; and
Service profiles 600.
   Profiler Engine

The profiler engine 510 may be a software program representing an algorithm that the service proxy 500 uses to analyze a client message and determine at least one message resource requirement for that message.

To follow an example given above, in an embodiment the profiler engine 510 may be designed to determine the number of patient insurance claims in a client message. For example, the profiler engine 510 could be designed to analyze the following JAVA code in a client message and determine that the message contained three claims:

<batch of claims>

<claim></claim>
<claim></claim>
<claim></claim>

<batch of claims>

Such an analysis could be useful for determining to send such a message to a Web service endpoint for validating patient insurance claims that is capable of filing a batch of up to 10,000 claims in a minute, but not to a more expensive Web service endpoint capable of filing 100,000 claims in a minute.

For example, the profiler engine 510 may contain the following JAVA code to count the number of claims in a message and add a SOAP message header showing that number:

void characterize (SOAPMessage msg) {

int bodySize = msg.getBody ( ).length ( )
msg.add Header (“ProcessingTime”,bodySize);

}

The service proxy 500 also uses the profiler engine 510 to identify message resource requirements for a client message in a message profile tag 512 that the profiler engine 510 appends to a message. The following example shows a message profile tag 512 that indicates that a message contains 10,000 claims to be filed.

<Header>

<ProcessingTime> 10000 <ProcessingTime>

<Header>

Resource Allocation Engine

The resource allocation engine 520 may be a software program representing an algorithm that the service proxy 500 uses to match message resource requirements identified in the message profile tag 512 with the most appropriate service profile 600, shown in FIG. 4, stored in metadata storage 400.

For example, the following lines represent a rule in the resource allocation engine 520 to send messages with more that 10,000 claims to be filed to the endpoint for Web service 2 620, shown in FIG. 1, and messages with 10,000 or fewer claims to the endpoint for Web service 1 610.

Header: ProcessingTime

Type: integer 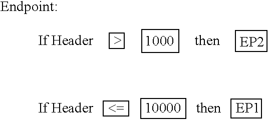
Invocation Engine

The invocation engine 530, shown in FIG. 5, may be a software program that the service proxy 500 employs to route a client message to the Web service 210, shown in FIG. 1, identified by the appropriate service profile 610, shown in FIG. 4. The invocation engine 530, shown in FIG. 5, is also used to activate the Web service, for example Web service 1 210 shown in FIG. 1, to execute the request contained in that message.

Determining Client-Message Resource Requirements

Returning to FIG. 2, after the resource allocation system 300 has been set up the process continues to the following step in an embodiment:

Step 2000 in FIG. 2. Determine client message resource requirement.

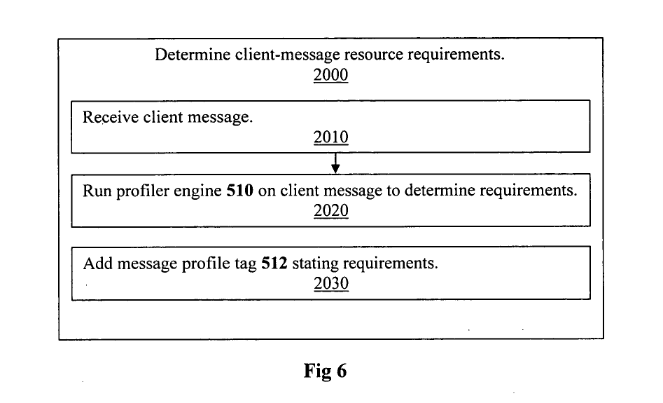

FIG. 6 shows the further steps in an embodiment for Step 2000.

Step 2010 in FIG. 6. Receive client message.

The service proxy 500, shown in FIG. 1, receives a message from a client, such as client 1 150, for example.

Step 2020 in FIG. 6. Run profiler engine 510 on client message to determine requirements.

As mentioned above, the service proxy 500, shown in FIG. 5, uses the profiler engine 510 to analyze the message and determine message resource requirements for that message.

Step 2030 in FIG. 6. Add message profile tag 512 stating requirements.

The service proxy 500 also uses the profiler engine 510 to identify message resource requirements by the message in a message profile tag 512 that the profiler engine 510 appends to that message.

Message Profile Tag

The message profile tag 512 is code added to the message to identify message resource requirements that the message requires. This code might take different forms for different types of messages. For example, the code could be designed to be compatible with SOAP messages.

Soap Envelopes

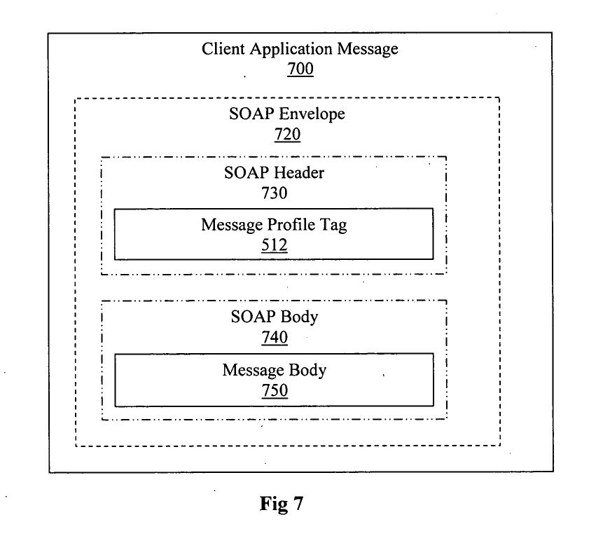

A standard called SOAP (Simple Object Access Protocol) has been developed to define the format of messages exchanged among Web service applications. To communicate with a Web service, a client application message 700, shown in FIG. 7, typically contains a SOAP envelope 720, which in turn contains a SOAP header 730 section and a SOAP body 740 section with a message body 750.

The message body 750 indicates the message being sent to the Web service, for example a request to calculate the number of patient claims at a health insurance company.

The message profile tag 512 could be added to the SOAP header 730.

Example of a Message Profile Tag in a SOAP Header

The following code is an example of a message profile tag 512 that could be added to a SOAP message to identify that the required capability for a client message is 100 “UnitsOfWor”.

<soap:Envelope xmlns:soap=“http://schemas.xmlsoap.org/soap/envelope/”>
<soap:Header>
<wsmp:MessageProfile
xmlns:wsmp=“http://schemas.webifysolutions.com/ws/2004/03/messageprofile”
xmlns:hta=“http://schemas.webifysolutions.com/2004/hta”>
<!-- States that this message contains 100 units of work -->
<wsmp:UnitsOfWork>100</wsmp:UnitsOfWork>
<!-- Domain specific element: States that this message is an ANSI 837p -->
<hta:ANSI837Type>professional</hta:ANSI837Type>
</wsmp:MessageProfile>
</soap:Header>
<soap:Body>
...
</soap:Body>
</soap:Envelope>

Dynamically Routing the Message

To return to FIG. 2, after determining the client-message resource requirements the process continues to the following step in an embodiment:

Step 3000 in FIG. 2. Direct client message to appropriate resource for execution.

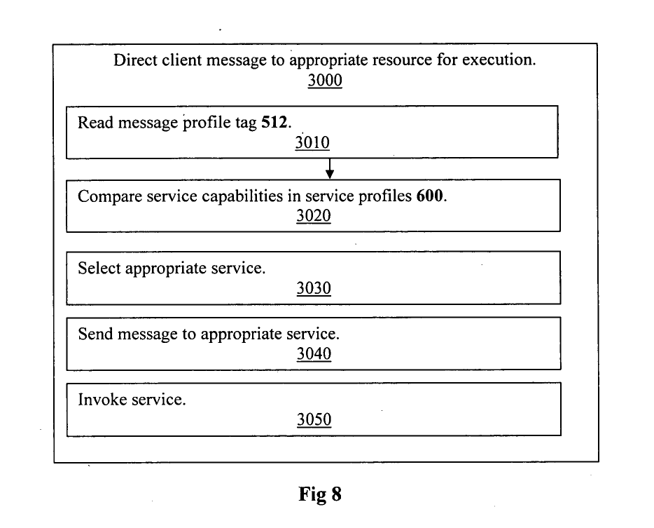

FIG. 8 shows the further steps for Step 3000 in an embodiment.

Step 3010 in FIG. 8. Read message profile tag 512.

The service proxy 500, shown in FIG. 5, uses the resource allocation engine 520 to read the message profile tag 512 appended to the message.

Step 3020 in FIG. 8. Compare resource capabilities in service profiles 600.

The service proxy 500, shown in FIG. 5, uses the resource allocation engine 520 to compare web mailing her new home were some of the members were called to move, who didn't push message resource requirements identified in the message profile tag 512 with the capabilities listed in the service profiles 600 stored in metadata storage 400, shown in FIG. 4.

Step 3030 in FIG. 8. Select appropriate service.

The service proxy 500, shown in FIG. 5, uses the resource allocation engine 520 to match M message resource requirements identified in the message profile tag 512 with the most appropriate service profile, for example 610, stored in metadata storage 400, shown in FIG. 4, and to select that service profile 610.

Step 3040 in FIG. 8. Send message to appropriate service.

The service proxy 500, shown in FIG. 5, uses the invocation engine 530 to route the client message to the Web service 210, shown in FIG. 1, identified by the appropriate service profile 610, shown in FIG. 5.

Step 3050 in FIG. 8. Invoke service.

The service proxy 500, shown in FIG. 5, uses the invocation engine 530 to activate the Web service 210, shown in FIG. 1, to execute the request contained in that message.

Computer System Overview

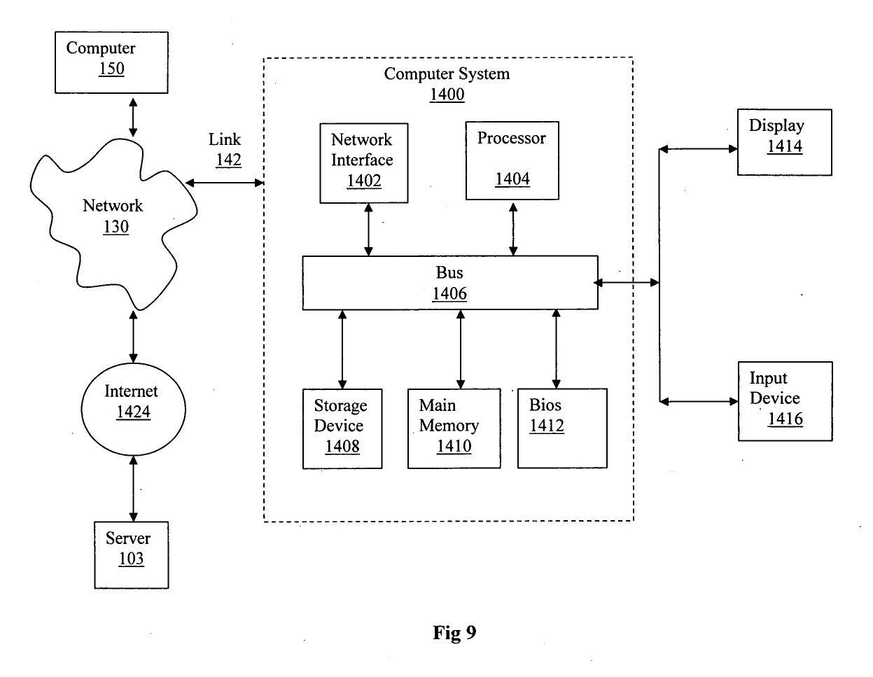

FIG. 9 is a block diagram that illustrates an example of a typical computer system 1400, well known to those skilled in the art, representing a Web service provider server 100 on which embodiments of the present invention can be implemented. This computer system 1400 comprises a network interface 1402 that provides two-way communications through a wired or wireless link 142 to a wired or wireless communications network 130 that uses any applicable communications technology. For example, the network 130 can comprise a public telephone network, a wireless network, a local area network (LAN), and any known or not-yet-known applicable communications technologies, using correspondingly applicable links. The network 130 in turn provides communications with one or more host computers 150 and, through the Internet 1424, with one or more servers 103.

The network interface 1402 is attached to a bus 1406 or other means of communicating information. Also attached to the bus 1406 are the following:
a processor 1404 for processing information;
a storage device 1408, such as an optical disc, a magneto-optical disc, or a magnet disc, for storing information and instructions;
main memory 1410, which is a dynamic storage device such as a random access memory (RAM) that stores information and instructions to be carried out by processor 1404;
a bios 1412 or another form of static memory such as read only memory (ROM), for storing static information and instructions to be carried out by processor 1404;
a display 1414, such as a liquid crystal display (LDC) or cathode ray tube (CRT) for displaying information to user of the computer system 1400; and
an input device 1416, with numeric and alphanumeric keys for communicating information and commands to processor 1404. In another embodiment a mouse or other input devices can also be used.

The computer system 1400 is used to implement the methods of the present invention in one embodiment. However, embodiments of the present invention are not limited to specific software and hardware configurations. Computer system 1400 can receive data comprising client application messages from computer 150 and server 103 used by client business, through a network 130 such as the Internet, and appropriate links 142, such as wired or wireless ones, and its network interface 1402. It can of course transmit data back to client business application over the same routes.

Computer system 1400 carries out the methods of the present invention when its processor 1404 processes instructions contained in its main memory 1410. Another computer-readable medium, such as its storage device 1408, may read these instructions into main memory 1410 and may do so after receiving these instructions through network interface 1402. Processor 1404 further processes data according to instructions contained in its storage device 1408. Data is relayed to appropriate elements in computer system 1400 through its bus 1406. Instructions for computer system 1400 can also be given through its input device 1416 and display 1414.

“Computer-readable medium” refers to any medium that provides instructions to processor 1404, comprising volatile, non-volatile, and transmission media. Volatile media comprise dynamic memory, such as main memory 1410. Non-volatile media comprise magnetic, magneto-optical, and optical discs, such as storage device 1408. Transmission media comprise a wide range of wired and unwired transmission technology, comprising cables, wires, modems, fiber optics, acoustic waves, such as radio waves, for example, and light waves, such as infrared, for example. Typical examples of widely used computer-readable media are floppy discs, hard discs, magnetic tape, CD-ROMs, punch cards, RAM, EPROMs, FLASH-EPOMs, memory cards, chips, and cartridges, modem transmissions over telephone lines, and infrared waves. Multiple computer-readable may be used, known and not yet known, can be used, individually and in combinations, in different embodiments of the present invention.

### Alternate Embodiments

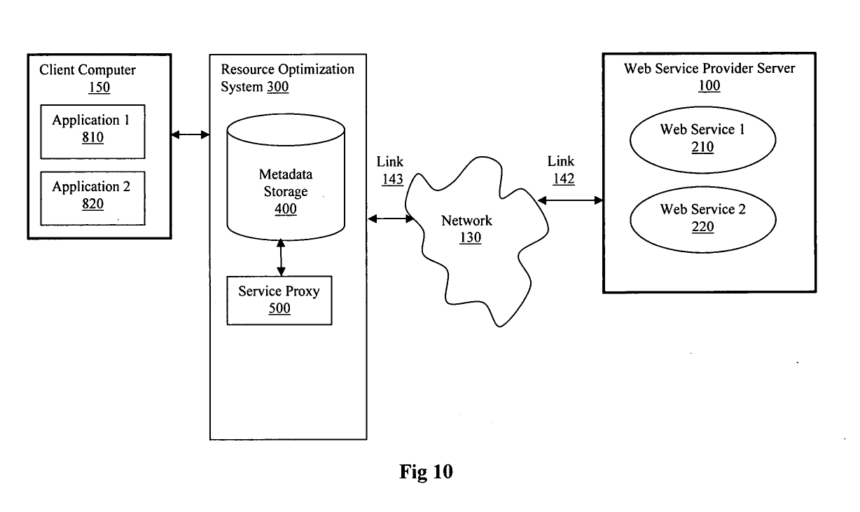

The previous extended description has explained some of the alternate embodiments of the present invention. It will be apparent to those skilled in the art that many other alternate embodiments of the present invention are possible without departing from its broader spirit and scope. For example, FIG. 10 is a block diagram showing an alternate operating environment in which embodiments of the present invention may be employed. In this alternate operating environment, the resource-optimization system 300 can be attached to the client computer 150, as an internal element or a plug-in module, instead of to a Web service provider server 100 as shown in FIG. 1.

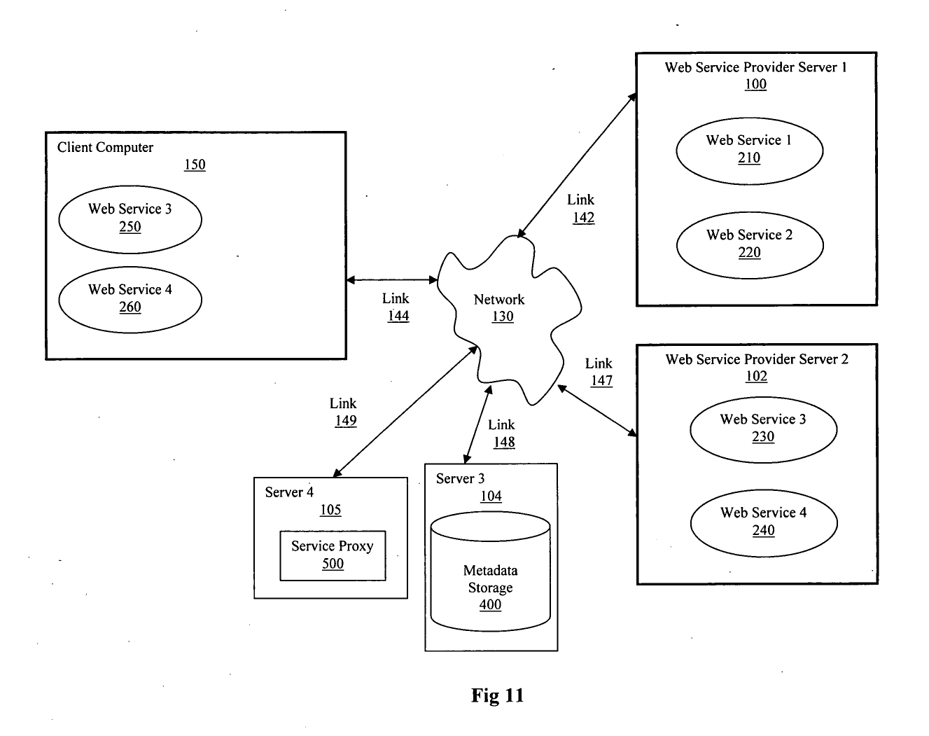

Other embodiments of the present invention are possible where the elements of the system are widely and diversely dispersed. For example, FIG. 11 is a block diagram showing a second alternate operating environment in which embodiments of the present invention may be employed. In this example, the service proxy 500 may be on server 105 and the metadata storage 400 on another server 104. Web services 210 and 220 may be on another server 100, more Web services 230 and 240 on another server 102, and additional Web services 250 and 260 on a client computer 150, all interrelated through such a loose system. Communications among these separated elements take place through a network 130 and multiple links: 142, 144, 147, 148, and 149.

It will also be apparent to those skilled in the art that different embodiments of the present invention may employ a wide range of possible hardware and of software techniques. For example the communication between a Web service provider and client business computers could take place through any number of links, including wired, wireless, infrared, or radio ones, and through other communication networks beside those cited, including any not yet in existence.

Also, the term computer is used here in its broadest sense to include personal computers, laptops, telephones with computer capabilities, personal data assistants (PDAs) and servers, and it should be recognized that it could include multiple servers, with storage and software functions divided among the servers. A wide array of operating systems, compatible e-mail services, Web browsers and other communications systems can be used to transmit messages among client applications and Web services.

Furthermore, in the previous description the order of processes, their numbered sequences, and their labels are presented for clarity of illustration and not as limitations on the present invention.

What is claimed is:

1. A method for automatically routing an electronic message to a selected Web service endpoint for the efficient processing of the electronic message, the method comprising the computer-implemented steps of
predefining a resource-optimization system for a client application message between a Web service and a source, such that the resource-optimization system comprises automatically
identifying at least one resource capability for each of a plurality of Web service endpoints,
determining at least one message resource requirement of the client application message based on the content of the client application message, and
selecting an appropriate Web service endpoint based on the message resource requirement of the client application message and the resource capability of the appropriate Web service endpoint; and
dynamically routing the electronic message by
determining, with the resource-optimization system, at least one resource requirement of the electronic message based on the content of the electronic message,
determining, with the resource-optimization system, the selected Web service endpoint based on the resource requirement of the electronic message and the resource capability of the selected Web service endpoint, and
directing the electronic message to the selected Web service endpoint for execution.

2. The method of claim 1 wherein predefining a resource-optimization system further comprises
setting up a metadata storage, the metadata storage comprising service profiles that specify information about a plurality of resource capabilities for each of the plurality of Web service endpoints.

3. The method of claim 1 wherein predefining a resource-optimization system for a client application message between a Web service and a source further comprises
setting up a service proxy to identify the message resource requirement for the client application message and to route the client application message to the appropriate Web service endpoint, the service proxy comprising
a profiler engine that
analyzes the content of the client application message, determines the message resource requirement for the client application message, and
appends to the client application message a message profile tag identifying the message resource requirement for the client application message;
a resource allocation engine that
matches the message resource requirement identified in the message profile tag with the most appropriate service profile stored in a metadata storage; and
an invocation engine that
routes the client application message to the Web service identified by the appropriate service profile, and
activates the Web service to execute a request contained in the client application message.

4. The method of claim 3 wherein the message profile tag further comprises a header in a SOAP (Simple Object Access Protocol) envelope.

5. A method for routing an electronic message to a selected Web service endpoint 210 for the efficient processing of the electronic message, the method comprising the computer-implemented steps of
predefining a resource-optimization system for a client application message between a Web service and a source, such that the resource-optimization system comprises automatically
identifying a plurality of resource capabilities for each of a plurality of Web service endpoints,
storing, in a metadata storage, a service profile which specifies information about the resource capabilities for each of the plurality of Web service endpoints,
setting up a service proxy to identify a message resource requirement for the client application message and to route the client application message to an appropriate Web service endpoint; and
dynamically routing the electronic message by
determining, with the resource-optimization system, the resource requirement of the electronic message based on the content of the electronic message,
determining, with the resource-optimization system, the selected Web service endpoint based on the resource requirement of the electronic message and the resource capability of the selected Web service endpoint, and
directing the electronic message to the selected Web service endpoint for execution.

6. The method of claim 5 wherein setting up a service proxy to identify a message resource requirement for the client application message and to route the client application message to an appropriate Web service endpoint further comprises
providing a profiler engine that
analyzes the content of the client application message,
determines the message resource requirement for the client application message, and
appends to the client application message a message profile tag identifying the message resource requirement for the client application message;
providing a resource allocation engine that
matches the message resource requirement identified in the message profile tag with the most appropriate service profile stored in a metadata storage; and
providing an invocation engine that
routes the client application message to the Web service identified by the appropriate service profile, and
activates the Web service to execute a request contained in the client application message.

7. The method of claim 6 wherein the message profile tag further comprises a header in a SOAP (Simple Object Access Protocol) envelope.

8. A resource-optimization system that characterizes the content of client messages before the transmission of the client messages to final Web service endpoints, and routes the client messages to appropriate Web service endpoints dynamically, based on message content, the system comprising
a first server;
a resource optimization system provided on the first server, the resource optimization system comprising
a metadata storage,
a service proxy, and
at least two Web services;
at least one client server;
an application provided on the client server, such that the application can send electronic messages; and
a network interface between the first server and at least one client server, such that electronic messages can be transferred between the servers.
